(19) United States
(12) Patent Application Publication
(10) Pub. No.: US 2024/0067447 A1
(43) Pub. Date: Feb. 29, 2024

(54) CARRYING ROBOT, CARRYING CONTROL METHOD, CONTROL DEVICE, AND WAREHOUSE SYSTEM

(71) Applicant: Shanghai Quicktron Intelligent Technology Co., LTD, Shanghai (CN)

(72) Inventors: Yundi He, Shanghai (CN); Dan Tang, Shanghai (CN); Tang Tang, Shanghai (CN)

(73) Assignee: Shanghai Quicktron Intelligent Technology Co., LTD, Shanghai (CN)

(21) Appl. No.: 18/269,941

(22) PCT Filed: Feb. 22, 2022
(86) PCT No.: PCT/CN2022/077166

§ 371 Date: Jun. 27, 2023

(30) Foreign Application Priority Data
Dec. 28, 2020 (CN) 202011585921.0

(51) Int. Cl. B65G 1/04; B65G 1/137; B66F 9/06; B66F 9/14; B66F 9/20

(52) U.S. Cl. CPC B65G 1/0421; B65G 1/1375; B66F 9/063; B66F 9/142; B66F 9/20

(57) ABSTRACT

Provided are a carrying robot, a carrying control method, a control device and a warehouse system. The carrying robot is applicable to a carrying scenario where boxes with at least two specifications are placed on a shelf and includes a cargo carrying apparatus. The cargo carrying apparatus includes a bottom pallet, a spacing adjustment mechanism and a first fork arm and a second fork arm which are disposed opposite to each other. The first fork arm and the second fork arm are disposed on two opposite sides of the bottom pallet, respectively. The carrying control method includes: controlling the spacing adjustment mechanism to adjust spacing between the first fork arm and the second fork arm; and controlling the cargo carrying apparatus to work and carry the box to be carried to the bottom pallet.

This application claims priority to Chinese Patent Application No. 202011585921.0 filed with the China National Intellectual Property Administration (CNIPA) on Dec. 28, 2020, the disclosure of which is incorporated herein by reference in its entirety.

### TECHNICAL FIELD

The present application relates to the technical field of warehousing, for example, a carrying robot, a carrying control method, a control device and a warehouse system.

### BACKGROUND

At present, in a warehousing industry, different carrying robots need to be configured for different sizes of boxes so that a utilization rate of the carrying robots is reduced and a carrying cost of boxes is increased.

### SUMMARY

Embodiments of the present application provide a carrying robot, a carrying control method, a control device and a warehouse system to improve the case of a low utilization rate of a carrying robot and a high carrying cost for carrying boxes in the related art.

As a first aspect of the embodiments of the present application, the embodiments of the present application provide a carrying robot, which is applicable to a carrying scenario where boxes with at least two specifications are placed on a shelf. The carrying robot includes a movable chassis, a cargo carrying apparatus disposed on the chassis and a lifting apparatus configured to adjust a height of the cargo carrying apparatus. The cargo carrying apparatus includes a first fork arm, a second fork arm, a spacing adjustment mechanism and a telescopic mechanism.

The first fork arm and the second fork arm are disposed opposite to each other.

The spacing adjustment mechanism is connected to the first fork arm and the second fork arm and configured to adjust spacing between the first fork arm and the second fork arm so that the spacing between the first fork arm and the second fork arm is matched with a box to be carried.

The telescopic mechanism is connected to the first fork arm and the second fork arm and configured to control the first fork arm and the second fork arm to stretch out and retract.

As a second aspect of the embodiments of the present application, the embodiments of the present application provide a box carrying control method, which is performed by a carrying robot. The carrying robot may be applicable to a carrying scenario where boxes with at least two specifications are placed on a shelf. The carrying robot includes a cargo carrying apparatus. The cargo carrying apparatus includes a bottom pallet, a spacing adjustment mechanism, a first fork arm and a second fork arm. The first fork arm and the second fork arm are disposed opposite to each other. The first fork arm and the second fork arm are disposed on two opposite sides of the bottom pallet, respectively. The method includes the steps described below.

The carrying robot is controlled to move so that a position of the cargo carrying apparatus corresponds to a current position of a box to be carried.

The spacing adjustment mechanism is controlled to adjust spacing between the first fork arm and the second fork arm so that the spacing between the first fork arm and the second fork arm is matched with the box to be carried.

The cargo carrying apparatus is controlled to work so that the first fork arm and the second fork arm restrict the box to be carried and carry the box to be carried from the current position to the bottom pallet.

As a third aspect of the embodiments of the present application, the embodiments of the present application provide a box carrying control method, which is performed by a carrying robot. The carrying robot may be applicable to a carrying scenario where boxes with at least two specifications are capable of being placed on a shelf. The carrying robot includes a cargo carrying apparatus. The cargo carrying apparatus includes a bottom pallet, a spacing adjustment mechanism, a first fork arm and a second fork arm. The first fork arm and the second fork arm are disposed opposite to each other. The first fork arm and the second fork arm are disposed on two opposite sides of the bottom pallet, respectively. The method includes the steps described below.

The carrying robot is controlled to move so that a position of the cargo carrying apparatus corresponds to a target position of a box to be carried.

The spacing adjustment mechanism is controlled to adjust spacing between the first fork arm and the second fork arm so that the spacing between the first fork arm and the second fork arm is matched with the box to be carried.

The cargo carrying apparatus is controlled to work so that the first fork arm and the second fork arm restrict the box to be carried and carry the box to be carried from the bottom pallet to the target position.

As a fourth aspect of the embodiments of the present application, the embodiments of the present application provide a box carrying control method, which is performed by a carrying robot. The carrying robot may be applicable to a carrying scenario where boxes with at least two specifications are capable of being placed on a shelf. The carrying robot includes multiple layers of cargo positions, a cargo carrying apparatus and a lifting apparatus. The cargo carrying apparatus includes a bottom pallet, a spacing adjustment mechanism, a first fork arm and a second fork arm. The first fork arm and the second fork arm are disposed opposite to each other. The first fork arm and the second fork arm are disposed on two sides of the bottom pallet, respectively. The method includes the steps described below.

The carrying robot is controlled to move so that a position of the cargo carrying apparatus corresponds to a target location of a target position of a box to be carried.

The lifting apparatus is controlled to work so that a height of the cargo carrying apparatus corresponds to a current cargo position of the box to be carried.

The spacing adjustment mechanism is controlled to adjust spacing between the first fork arm and the second fork arm so that the spacing between the first fork arm and the second fork arm is matched with the box to be carried.

The cargo carrying apparatus is controlled to work so that the first fork arm and the second fork arm restrict the box to be carried and carry the box to be carried from the current cargo position to the bottom pallet.

The lifting apparatus is controlled to work so that the height of the cargo carrying apparatus corresponds to a height of the target position of the box to be carried and the box to be carried is carried from the bottom pallet to the target position.

As a fifth aspect of the embodiments of the present application, the embodiments of the present application provide a control device. The control device includes at least one processor and a memory communicatively connected to the at least one processor.

The memory stores instructions executable by the at least one processor, and the instructions are executed by the at least one processor to cause the at least one processor to perform the method described above.

As a sixth aspect of the embodiments of the present application, the embodiments of the present application provide a warehouse system. The warehouse system includes multiple shelves, the carrying robot described above and the control device described above.

Each of the multiple shelves includes at least one buffer layer board and at least one storage layer board, where each of the at least one storage layer board is spaced from each of the at least one buffer layer board in a vertical direction, and boxes with at least two specifications are capable of being placed on the at least one buffer layer board and/or the at least one storage layer board.

The carrying robot is configured to carry a box between the at least one storage layer board and the at least one buffer layer board.

### BRIEF DESCRIPTION OF DRAWINGS

In the drawings, the same reference numerals throughout multiple drawings indicate the same or similar components or elements unless otherwise specified. These drawings are not necessarily drawn to scale. It is to be understood that these drawings depict only some embodiments disclosed according to the present application and are not to be construed as limiting the scope of the present application.

FIG. 1 is a flowchart of a box carrying control method according to an embodiment of the present application.

FIG. 2 is a top view after a first shift lever and a second shift lever are stretched out according to an embodiment of the present application.

FIG. 3 is a top view where a first fork arm and a second fork arm clamp a box to be carried according to an embodiment of the present application.

FIG. 4 is a flowchart of a box carrying control method according to an embodiment of the present application.

FIG. 5 is a flowchart of a box carrying control method according to an embodiment of the present application.

FIG. 6 is a perspective view of a warehousing apparatus according to an embodiment of the present application.

FIG. 7 is a plan view of a warehousing apparatus according to an embodiment of the present application.

FIG. 8 is a block diagram of a box carrying control device according to an embodiment of the present application.

FIG. 9 is a block diagram of a box carrying control device according to another embodiment of the present application.

FIG. 10 is a block diagram of a box carrying control device according to another embodiment of the present application.

FIG. 11 is a block diagram of a control device according to an embodiment of the present application.

### REFERENCE LIST

200 box to be carried
201 first fork arm
202 second fork arm
203 first shift lever
204 second shift lever
205 first pressure detection module
206 second pressure detection module
300 bottom pallet
400 shelf
401 buffer layer board
402 storage layer board
410 first shelf
420 second shelf
430 third shelf
440 fourth shelf
500 carrying robot
600 transport robot
701 box with first specification
702 box with second specification

### DETAILED DESCRIPTION

In the following, only some example embodiments are briefly described. As will be appreciated by those skilled in the art, the described embodiments may be modified in multiple different manners without departing from the spirit or scope of the present application. Therefore, the drawings and the descriptions are to be regarded as exemplary rather than limitative in nature.

An embodiment of the present application provides a carrying robot, which is applicable to a carrying scenario where boxes with at least two specifications are placed on a shelf. The carrying robot may include a movable chassis and a cargo carrying apparatus disposed on the chassis. The cargo carrying apparatus may include a spacing adjustment mechanism, a first fork arm and a second fork arm. The first fork arm and the second fork arm are disposed opposite to each other. The spacing adjustment mechanism is configured to adjust spacing between the first fork arm and the second fork arm so that the spacing between the first fork arm and the second fork arm is matched with a box to be carried.

In the related art, a carrying robot can only carry boxes with a fixed size and cannot adapt to a scenario where boxes with multiple specifications are carried. A telescopic cargo carrying mechanism is disposed on the carrying robot. The cargo carrying mechanism can be stretched out to a side surface of the box and pull the box from a storage position to a carrying robot body by hooking, pulling and retracting. In addition, an identifier (for example, a two-dimensional code) needs to be disposed on the box to assist the carrying robot to perform positioning and identification.

In the related art, the cargo carrying mechanism of the carrying robot includes two fork arms, where a distance between the two fork arms is fixed. Using the carrying robot to carry boxes has the following disadvantages: (1) since the distance between the two fork arms is fixed, the carrying robot can only carry boxes with a fixed size and cannot adapt to a scenario where boxes with multiple specifications are carried; (2) when a box has a relatively small size, in a process of hooking and pulling the box by the two fork arms, the box is prone to shift, resulting in an increased risk of failure when the box is pulled to the carrying robot body; (3) there are many limitations on the shape, specification and material of the box, and sometimes an operation of renovating the box needs to be added for the purpose of using a dedicated box, resulting in a waste of labor; (4) a width occupied by a single storage location of a shelf is the same, and if the box has a relatively small width, placing the box on the storage location of the shelf by the cargo carrying mechanism will cause a waste of space; and (5) an identifier needs to be disposed on the box and the storage location to assist the robot to identify the box, resulting in an increased cost and a consumption of operation working hours.

For the carrying robot in the embodiment of the present application, the spacing between the first fork arm and the second fork arm can be adjusted by the spacing adjustment mechanism so that the spacing between the first fork arm and the second fork arm is matched with the box to be carried. Therefore, the carrying robot may be applicable to boxes with multiple specifications and may be applicable to a carrying scenario where boxes with at least two specifications are placed on a shelf, thereby improving a utilization rate of the carrying robot, reducing a carrying cost of the boxes and widening an application range of the carrying robot. In addition, the adjustment of the spacing between the first fork arm and the second fork arm can better restrict the box and avoid the shift of the box in a process of pushing and pulling the box, thereby ensuring an accuracy rate and success rate of carrying the box to a robot body.

The spacing adjustment mechanism may include a drive motor and a transmission mechanism connected to the drive motor. The first fork arm and the second fork arm may be disposed on the transmission mechanism, and the drive motor rotates to drive the transmission mechanism to work so that the spacing between the first fork arm and the second fork arm is adjustable. For example, the transmission mechanism may include a threaded screw mechanism, a belt transmission mechanism or a gear transmission mechanism. A specific structure of the spacing adjustment mechanism is not limited here as long as the spacing between the first fork arm and the second fork arm can be adjusted.

In an embodiment, the cargo carrying apparatus may further include a bottom pallet. The bottom pallet can be used for transitionally carrying the box to be carried, and the first fork arm and the second fork arm are disposed on two opposite sides of the bottom pallet, respectively.

In an embodiment, the cargo carrying apparatus may include a telescopic mechanism. The telescopic mechanism is configured to control the first fork arm and the second fork arm to stretch out and retract. The telescopic mechanism is stretched out so that the first fork arm and the second fork arm can restrict the bin, and the telescopic mechanism is retracted so that the first fork arm and the second fork arm can pull the restricted box to the bottom pallet of the carrying robot.

The telescopic mechanism may be implemented using conventional techniques in the art. For example, the telescopic mechanism may include a driving motor, a lead screw connected to the driving motor and a support plate disposed on the lead screw. The first fork arm and the second fork arm may be disposed on the support plate, and the drive motor rotates to drive the support plate to move so that the first fork arm and the second fork arm are stretched out and retracted. The telescopic mechanism may also be a belt transmission mechanism or a gear transmission mechanism, which will not be repeated here.

The cargo carrying apparatus may further include an image acquisition module. The image acquisition module may be configured to acquire image information of the box to be carried. The image acquisition module may include a vision sensor, for example, a depth camera. The image acquisition module can be used for acquiring an image of the box to be carried. After the acquired image is processed by an algorithm, a size including a length, a width and a height of the box to be carried and relative position information of the box to be carried relative to the cargo carrying apparatus can be obtained.

In an embodiment, a first shift lever capable of being stretched out towards a side of the second fork arm may be disposed on an end of the first fork arm (for example, an end towards the box to be carried), and a second shift lever capable of being stretched out towards a side of the first fork arm may be disposed on an end of the second fork arm (for example, an end towards the box to be carried). After the telescopic mechanism is stretched out so that the box to be carried is located between the first fork arm and the second fork arm, the first shift lever and the second shift lever are stretched out to hook the box to be carried, and the telescopic mechanism is retracted so that the first fork arm and the second fork arm hook and pull the box to be carried to the bottom pallet through the first shift lever and the second shift lever. Specific structures of the first shift lever and the second shift lever may be implemented using conventional techniques in the art, which will not be repeated here.

In an embodiment, a first pressure detection module may be disposed on one side of the first fork arm towards the second fork arm, and/or a second pressure detection module may be disposed on one side of the second fork arm towards the first fork arm. Therefore, when the first fork arm and the second fork arm fit snugly around a surface of the box to be carried to clamp the box, a fitting pressure on the box can be obtained through the first pressure detection module and/or the second pressure detection module to avoid damage to the box due to an excessive fitting pressure. Such a structure enables the first fork arm and the second fork arm to clamp boxes with multiple materials, for example, a plastic box or a carton, in a fitting manner, so that a dedicated box does not need to be used, thereby avoiding an operation of renovating the box and saving working hours.

In an embodiment, the carrying robot may further include a lifting apparatus. The lifting apparatus is configured to adjust a height of the cargo carrying apparatus so that the height of the cargo carrying apparatus corresponds to a height of the box to be carried.

In the embodiment of the present application, a carrying principle of the carrying robot is generally as follows: after the carrying robot receives a carrying instruction, the movable chassis moves to a location corresponding to the box to be carried according to the carrying instruction, and the lifting apparatus adjusts the height of the cargo carrying apparatus so that the height of the cargo carrying apparatus corresponds to a height of a current position of the box to be carried; the cargo carrying apparatus carries the box to be carried to the bottom pallet of the carrying robot; the carrying robot moves to a location corresponding to a target position according to a planned path, and the lifting apparatus adjusts the height of the cargo carrying apparatus so that the height of the cargo carrying apparatus corresponds to a height of the target position; and the cargo carrying apparatus carries the box to be carried from the bottom pallet to the target position.

In an embodiment, the carrying robot may further include multiple layers of cargo positions. A carrying principle of the carrying robot is generally as follows: after the carrying robot receives a carrying instruction, the movable chassis moves to a location corresponding to the box to be carried according to the carrying instruction, and the lifting apparatus adjusts the height of the cargo carrying apparatus so that the height of the cargo carrying apparatus corresponds to a height of a current position of the box to be carried; the cargo carrying apparatus carries the box to be carried to the bottom pallet of the carrying robot; the lifting apparatus adjusts the height of the cargo carrying apparatus so that the height of the cargo carrying apparatus corresponds to a certain empty cargo position, and the cargo carrying apparatus carries the box to be carried from the bottom pallet to the cargo position; the carrying robot moves to a location corresponding to a target position according to a planned path, and the lifting apparatus adjusts the height of the cargo carrying apparatus so that the height of the cargo carrying apparatus corresponds to the corresponding cargo position; the cargo carrying apparatus carries the box to be carried from the cargo position to the bottom pallet; the lifting apparatus adjusts the height of the cargo carrying apparatus so that the height of the cargo carrying apparatus corresponds to a height of the target position; and the cargo carrying apparatus carries the box to be carried from the bottom pallet to the target position.

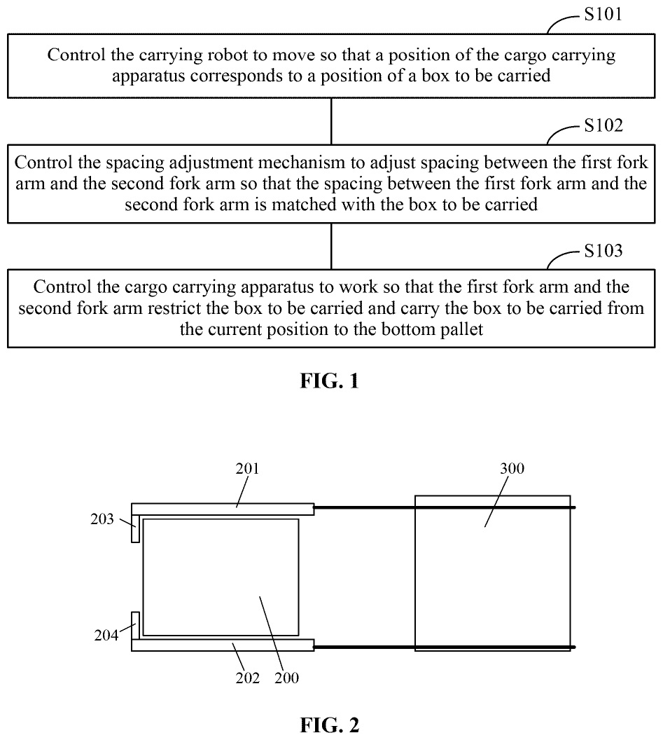

FIG. 1 is a flowchart of a box carrying control method according to an embodiment of the present application. An embodiment of the present application provides a box carrying control method, which is performed by a carrying robot. The carrying robot may be applicable to a carrying scenario where boxes with at least two specifications are placed on a shelf. The carrying robot may include a cargo carrying apparatus. The cargo carrying apparatus may include a bottom pallet, a spacing adjustment mechanism, a first fork arm and a second fork arm. The first fork arm and the second fork arm are disposed opposite to each other. The first fork arm and the second fork arm are disposed on two sides of the bottom pallet, respectively. As shown in FIG. 1, the box carrying control method may include the steps described below.

In S101, the carrying robot is controlled to move so that a position of the cargo carrying apparatus corresponds to a current position of a box to be carried.

In S102, the spacing adjustment mechanism is controlled to adjust spacing between the first fork arm and the second fork arm so that the spacing between the first fork arm and the second fork arm is matched with the box to be carried.

In S103, the cargo carrying apparatus is controlled to work so that the first fork arm and the second fork arm restrict the box to be carried and carry the box to be carried from the current position to the bottom pallet.

For example, the carrying robot may include a movable chassis, and the cargo carrying apparatus may be disposed on the chassis. A carrying instruction can be sent to the carrying robot to control the carrying robot to move. In the case where the carrying robot is under the control of the carrying instruction, the chassis moves to a location corresponding to the box to be carried so that the position of the cargo carrying apparatus corresponds to the current position of the box to be carried.

In step S102, “the spacing between the first fork arm and the second fork arm is matched with the box to be carried” may be understood as follows: the first fork arm and the second fork arm are parallel to each other, and the spacing between the first fork arm and the second fork arm is matched with a size of the box to be carried in a direction perpendicular to the first fork arm or the second fork arm. For example, the spacing between the first fork arm and the second fork arm is d1, the size of the box to be carried in the direction perpendicular to the first fork arm or the second fork arm is d2, and d1 is matched with d2. “d1 is matched with d2” may be understood as follows: d1 is slightly greater than d2, for example, d1 is 5% to 10% greater than d2.

Through the use of the box carrying control method in the embodiment of the present application, the carrying robot can carry boxes with multiple specifications and may be applicable to a carrying scenario where boxes with at least two specifications are placed on a shelf, thereby widening an application range of the carrying robot, improving a utilization rate of the carrying robot and reducing a carrying cost of the boxes. In addition, the spacing between the first fork arm and the second fork arm is matched with the box to be carried so that the carrying robot can better restrict the box and avoid the shift of the box in a process of carrying the box to be carried to the bottom pallet, thereby ensuring an accuracy rate and success rate of carrying the box to a robot body.

In an embodiment, in step S102, the spacing adjustment mechanism is controlled to adjust spacing between the first fork arm and the second fork arm may include: size information of the box to be carried is determined according to image information of the box to be carried; and the spacing adjustment mechanism is controlled according to the size information of the box to be carried to adjust the spacing between the first fork arm and the second fork arm.

For example, an image acquisition module may be disposed on the cargo carrying apparatus and can acquire the image information of the box to be carried. The image acquisition module may include a vision sensor, for example, a depth camera. The image acquisition module can be used for acquiring an image of the box to be carried. After the acquired image is processed by an algorithm, a size including a length, a width and a height of the box to be carried can be obtained. The spacing adjustment mechanism is controlled according to the determined size of the box to be carried to adjust the spacing between the first fork arm and the second fork arm so that the spacing between the first fork arm and the second fork arm is matched with the corresponding size of the box to be carried.

For example, a map table of the bin and the size information can be pre-stored in a system, and an identifier (for example, a two-dimensional code) may be disposed on the box to be carried. The box can be identified according to the identifier of the box to be carried, the size information of the box to be carried is obtained according to the map table of the box and the size information, and the spacing adjustment mechanism is controlled according to the obtained size information to adjust the spacing between the first fork arm and the second fork arm.

The size information of the box to be carried is determined according to the image information of the box to be carried so that the identifier for identifying the box can no longer be disposed on the box, thereby reducing a cost and reducing carrying working hours.

In an embodiment, the cargo carrying apparatus further includes a telescopic mechanism, and in step S103, the cargo carrying apparatus is controlled to work so that the first fork arm and the second fork arm restrict the box to be carried and carry the box to be carried from the current position to the bottom pallet, may include: relative position information between the box to be carried and the cargo carrying apparatus is determined according to the image information of the box to be carried; the telescopic mechanism is controlled according to the relative position information to stretch out so that the box to be carried is located between the first fork arm and the second fork arm; and the first fork arm and the second fork arm are controlled to restrict the box to be carried and carry the box to be carried from the current position to the bottom pallet.

The image acquisition module, for example, the depth camera, can acquire the image of the box to be carried. After the acquired image is processed by the algorithm, a relative position relationship between the box to be carried and the image acquisition module can be obtained, and a relative position relationship between the box to be carried and the cargo carrying apparatus is obtained. A distance between the box to be carried and the first fork arm or the second fork arm can be determined according to the relative position relationship, and an amount of stretching out of the telescopic mechanism is determined. After the telescopic mechanism is controlled according to the amount of stretching out to drive the first fork arm and the second fork arm to stretch out, the box to be carried is located between the first fork arm and the second fork arm, thereby facilitating the first fork arm and the second fork arm to restrict the box to be carried.

For example, a map table of the box and the position relationship can be pre-stored in a system, and an identifier (for example, a two-dimensional code) may be disposed on the box to be carried. The box to be carried can be identified according to the identifier, and a specific position of the box to be carried is obtained according to the map table of the box and the position relationship. A distance between the box to be carried and the cargo carrying apparatus can be obtained according to the specific position of the box to be carried so that a distance between the box to be carried and the first fork arm or the second fork arm is determined and an amount of stretching out of the telescopic mechanism is determined. After the telescopic mechanism is controlled according to the amount of stretching out to drive the first fork arm and the second fork arm to stretch out, the box to be carried is located between the first fork arm and the second fork arm, thereby facilitating the first fork arm and the second fork arm to restrict the box to be carried.

The relative position information between the box to be carried and the cargo carrying apparatus is determined according to the image information of the box to be carried so that the identifier for identifying the box can no longer be disposed on the bin, thereby further reducing a cost and further reducing carrying working hours.

In an embodiment, a first shift lever capable of being stretched out towards a side of the second fork arm is disposed on an end of the first fork arm, and a second shift lever capable of being stretched out towards a side of the first fork arm is disposed on an end of the second fork arm. The first fork arm and the second fork arm are controlled to restrict the box to be carried and carry the box to be carried from the current position to the bottom pallet, may include: the first shift lever and the second shift lever are controlled to stretch out to hook the box to be carried;

and the telescopic mechanism is controlled to retract so that the first fork arm and the second fork arm pull the box to be carried from the current position to the bottom pallet.

FIG. 2 is a top view after a first shift lever and a second shift lever are stretched out according to an embodiment of the present application. As shown in FIG. 2, after a telescopic mechanism drives a first fork arm 201 and a second fork arm 202 to stretch out, a box 200 to be carried is located between the first fork arm 201 and the second fork arm 202. A first shift lever 203 and a second shift lever 204 may be located on an end of the first shift lever 201 and an end of the second shift lever 202, respectively. Therefore, after the first shift lever 203 and the second shift lever 204 are stretched out, the box to be carried is restricted between the first fork arm 201, the second fork arm 202, the first shift lever 203 and the second shift lever 204. And the first shift lever 203 and the second shift lever 204 can hook the box to be carried. The telescopic mechanism is retracted (in a right direction in FIG. 2) so that the first fork arm and the second fork arm can pull the box 200 to be carried from a current position to a bottom pallet 300.

In an embodiment, the first fork arm and the second fork arm are controlled to restrict the box to be carried and carry the box to be carried to the bottom pallet, may include: the spacing adjustment mechanism is controlled to work to reduce the spacing between the first fork arm and the second fork arm; in the case where a fitting pressure between the first fork arm and the box to be carried and/or a fitting pressure between the second fork arm and the box to be carried is greater than or equal to a preset pressure, the spacing adjustment mechanism is controlled to stop working to clamp the box to be carried; and the telescopic mechanism is controlled to retract so that the first fork arm and the second fork arm carry the box to be carried from the current position to the bottom pallet.

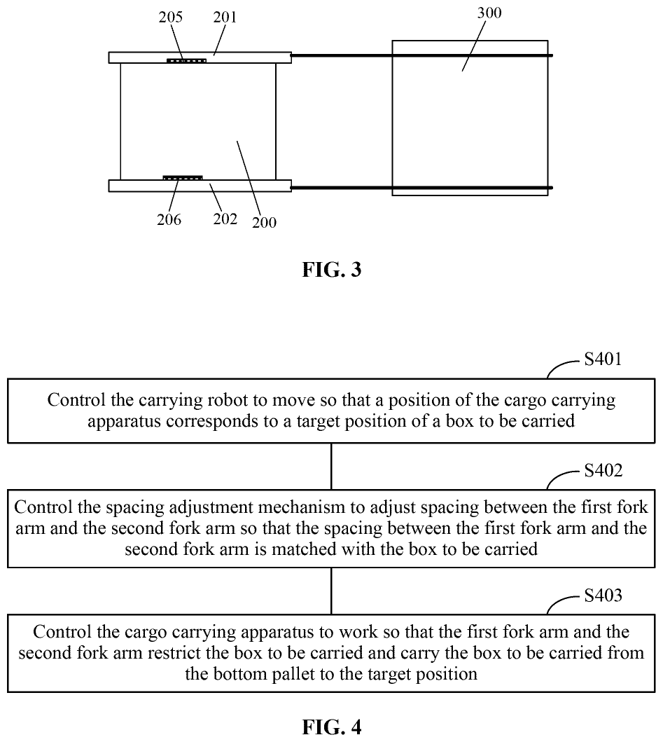

FIG. 3 is a top view where a first fork arm and a second fork arm clamp a box to be carried according to an embodiment of the present application. As shown in FIG. 3, after the telescopic mechanism drives the first fork arm 201 and the second fork arm 202 to stretch out, the box 200 to be carried is located between the first fork arm 201 and the second fork arm 202. To enable the first fork arm 201 and the second fork arm 202 to restrict the box 200 to be carried, a spacing adjustment mechanism can be controlled to work to reduce spacing between the first fork arm 201 and the second fork arm 202 such that both the first fork arm and the second fork arm fit snugly around the box to be carried. A first pressure detection module 205 may be disposed on one side of the first fork arm 201 towards the second fork arm 202, and/or a second pressure detection module 206 may be disposed on one side of the second fork arm 202 towards the first fork arm 201. A fitting pressure between the first fork arm 201 and the box 200 to be carried can be obtained by the first pressure detection module 205 and/or a fitting pressure between the second fork arm 202 and the box 200 to be carried can be obtained by the second pressure detection module 206. In the case where a fitting pressure is greater than or equal to a preset pressure, the spacing adjustment mechanism is controlled to stop working to clamp the box to be carried. After the first fork arm 201 and the second fork arm 202 clamp the box to be carried, the telescopic mechanism is retracted (in a right direction in FIG. 3), and the first fork arm and the second fork arm carry the box 200 to be carried from the current position to the bottom pallet 300.

The preset pressure can be determined according to a material of the box. An appropriate preset pressure is set to ensure that the first fork arm and the second fork arm can clamp the box without damaging the box. Therefore, the first fork arm and the second fork arm can be used for clamping boxes made of multiple materials, for example, a plastic box or a carton, in a fitting manner, so that a dedicated box does not need to be used, thereby avoiding an operation of renovating the box and saving working hours. Clamping the box in the fitting manner can completely restrict the movement of the box and can adapt to boxes with different specifications, and the secondary adjustment of the spacing between the first fork arm and the second fork arm can further improve carrying efficiency.

For example, the pressure detection module may include a pressure sensor or other components that can detect pressure. In other embodiments, a travel switch may be disposed to detect positions of the first fork arm and the second fork arm, and the spacing adjustment mechanism is controlled to work to reduce the spacing between the first fork arm and the second fork arm. When the travel switch is triggered, it indicates that the spacing between the first fork arm and the second fork arm has enabled the fitting pressure to be greater than or equal to the preset pressure.

In an embodiment, the carrying robot further includes a lifting apparatus. The lifting apparatus is configured to adjust a height of the cargo carrying apparatus. In step S101, the carrying robot is controlled to move so that a position of the cargo carrying apparatus corresponds to a current position of a box to be carried, may include: the current position corresponding to the box to be carried is determined according to the box to be carried; the carrying robot is instructed to move to a current location corresponding to the current position; the lifting apparatus is controlled to work to move the cargo carrying apparatus to a height corresponding to the current position; relative position information between the box to be carried and the cargo carrying apparatus is determined according to the image information of the box to be carried; and the carrying robot is instructed according to the relative position information to work to correct a position deviation between the cargo carrying apparatus and the box to be carried so that the position of the cargo carrying apparatus corresponds to the position of the box to be carried.

The current position of the box to be carried can be pre-stored in the system. When the box to be carried needs to be carried away from the current position, the system can determine the current position corresponding to the box to be carried according to the box to be carried. The system can look for a carrying robot in a state of capable of executing a task on a map. If there is no idle carrying robot, the system suspends the task to wait for an available carrying robot; if there is an idle carrying robot, the system plans a route to the current position for a carrying robot closest to the current position; the system sends an instruction and a route to move to the current position to the carrying robot, and the carrying robot moves to the current location corresponding to the current position according to the instruction and the route. It may be understood by those skilled in the art that the current position of the box to be carried may be a position in three-dimensional space and a coordinate of the current position may be (X1, Y1, Z1), where X1 and Y1 are ground positions and Z1 may be a height position. The current location corresponding to the current position may be understood as a ground position corresponding to the current position, that is, a ground position represented by (X1, Y1). After the carrying robot moves to the current location corresponding to the current position, the system can control the lifting apparatus to work to move the cargo carrying apparatus to the height corresponding to the current position.

In the above process, the carrying robot moves according to the current position pre-stored in the system. However, in practice, there may be a deviation between an actual position of the box to be carried and the current position stored in the system. For example, the image information of the box to be carried can be obtained by the image acquisition module, and the relative position information between the box to be carried and the cargo carrying apparatus can be determined according to the image information of the box to be carried. The carrying robot is instructed according to the relative position information to adjust in ground and height directions to correct the position deviation between the cargo carrying apparatus and the box to be carried so that the position of the cargo carrying apparatus corresponds to the position of the box to be carried. Therefore, when the first fork arm and the second fork arm are stretched out towards the box to be carried, the first fork arm and the second fork arm do not touch the box to be carried so that the box to be carried is located between the first fork arm and the second fork arm.

Using the box carrying control method in the embodiment of the present application can correct the position deviation between the cargo carrying apparatus and the box to be carried, ensure that the first fork arm and the second fork arm can accurately restrict the box to be carried and improve the carrying efficiency.

In an embodiment, the carrying robot may further include a body shelf. The body shelf may include multiple layers of cargo positions, and the bottom pallet may serve as a position for transitionally placing the box to be carried. After the box to be carried is carried to the bottom pallet, the lifting apparatus can adjust the height of the cargo carrying apparatus so that a height of the bottom pallet corresponds to a certain empty cargo position, and the first fork arm and the second fork arm can carry the box to be carried from the bottom pallet to the corresponding cargo position. Such a carrying robot can carry multiple boxes at the same time, thereby further improving the carrying efficiency.

The box carrying control method in the preceding embodiment is applicable to carrying a box to be carried at a current position to a cargo position of a carrying robot by the carrying robot. The following embodiment specifically describes a control method of carrying a box to be carried at a cargo position to a target position by a carrying robot.

FIG. 4 is a flowchart of a box carrying control method according to an embodiment of the present application. The box carrying control method in the embodiment of the present application may be applicable to a carrying robot. The carrying robot may be applicable to a carrying scenario where boxes with at least two specifications are capable of being placed on a shelf. The carrying robot may include a cargo carrying apparatus. The cargo carrying apparatus includes a bottom pallet, a spacing adjustment mechanism, a first fork arm and a second fork arm. The first fork arm and the second fork arm are disposed opposite to each other. The first fork arm and the second fork arm are disposed on two opposite sides of the bottom pallet, respectively. As shown in FIG. 4, the box carrying control method may include the steps described below.

In S401, the carrying robot is controlled to move so that a position of the cargo carrying apparatus corresponds to a target position of a box to be carried.

In S402, the spacing adjustment mechanism is controlled to adjust spacing between the first fork arm and the second fork arm so that the spacing between the first fork arm and the second fork arm is matched with the box to be carried.

In S403, the cargo carrying apparatus is controlled to work so that the first fork arm and the second fork arm restrict the box to be carried and carry the box to be carried from the bottom pallet to the target position.

The box to be carried that needs to be carried to the target position is placed on the bottom pallet of the carrying robot. A system can determine the target position of the box to be carried according to the box to be carried. The system plans a route to the target position for the carrying robot. The system sends an instruction and a route to move to the target position to the carrying robot, and the carrying robot can move to a target location corresponding to the target position according to the instruction and the route. The system controls a lifting apparatus of the carrying robot to adjust a height of the cargo carrying apparatus so that the height of the cargo carrying apparatus corresponds to a target height of the target position. Therefore, the position of the cargo carrying apparatus corresponds to the target position.

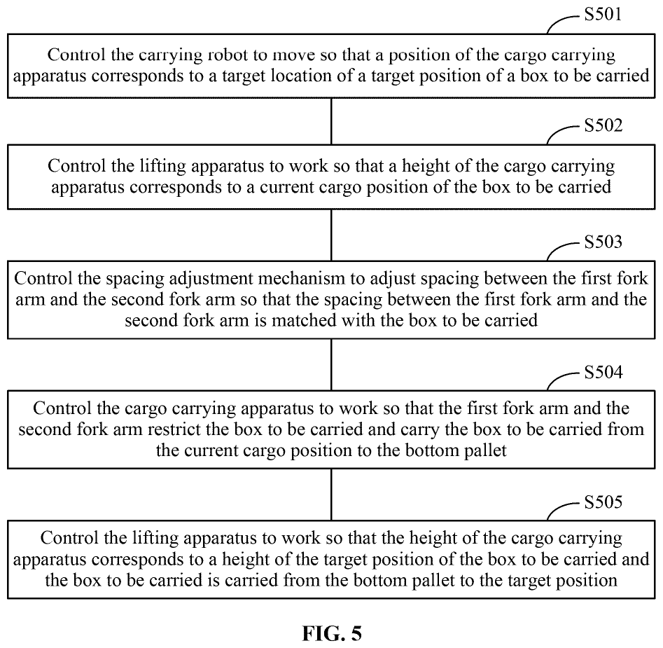

FIG. 5 is a flowchart of a box carrying control method according to an embodiment of the present application. The box carrying control method in the embodiment of the present application may be applicable to a carrying robot. The carrying robot may be applicable to a carrying scenario where boxes with at least two specifications are capable of being placed on a shelf. The carrying robot includes multiple layers of cargo positions, a cargo carrying apparatus and a lifting apparatus. The cargo carrying apparatus includes a bottom pallet, a spacing adjustment mechanism, a first fork arm and a second fork arm. The first fork arm and the second fork arm are disposed opposite to each other. The first fork arm and the second fork arm are disposed on two opposite sides of the bottom pallet, respectively. The box carrying control method may include the steps described below.

In S501, the carrying robot is controlled to move so that a position of the cargo carrying apparatus corresponds to a target location of a target position of a box to be carried.

In S502, the lifting apparatus is controlled to work so that a height of the cargo carrying apparatus corresponds to a current cargo position of the box to be carried.

In S503, the spacing adjustment mechanism is controlled to adjust spacing between the first fork arm and the second fork arm so that the spacing between the first fork arm and the second fork arm is matched with the box to be carried.

In S504, the cargo carrying apparatus is controlled to work so that the first fork arm and the second fork arm restrict the box to be carried and carry the box to be carried from the current cargo position to the bottom pallet.

In S505, the lifting apparatus is controlled to work so that the height of the cargo carrying apparatus corresponds to a height of the target position of the box to be carried and the box to be carried is carried from the bottom pallet to the target position.

The order of steps S501 and S502 may be changed.

It may be understood by those skilled in the art that the target position of the box to be carried may be a position in three-dimensional space and a coordinate of the target position may be (X2, Y2, Z2), where X2 and Y2 are ground positions, and Z2 may be a height position. The target location corresponding to the target position may be understood as a ground location corresponding to the target position, that is, a location represented by a coordinate (X2, Y2).

In steps S504 and S505, the first fork arm and the second fork arm restrict the box to be carried and carry the box to be carried from the current cargo position to the bottom pallet, and after the cargo carrying apparatus is lifted to the height corresponding to the target position, the first fork arm and the second fork arm continue to carry the box to be carried from the bottom pallet to the target position. In the process of steps S504 to S505, the first fork arm and the second fork arm remain in a state of restricting the box to be carried until the box to be carried is carried to the target position.

In an embodiment, in steps S402 and S503, the spacing adjustment mechanism is controlled to adjust spacing between the first fork arm and the second fork arm, may include: size information of the box to be carried is determined according to image information of the box to be carried; and the spacing adjustment mechanism is controlled according to the size information of the box to be carried to adjust the spacing between the first fork arm and the second fork arm.

An image acquisition module can be used for acquiring an image of the box to be carried. After the acquired image is processed by an algorithm, a size including a length, a width and a height of the box to be carried can be obtained. The spacing adjustment mechanism is controlled according to the determined size of the box to be carried to adjust the spacing between the first fork arm and the second fork arm so that the spacing between the first fork arm and the second fork arm is matched with the corresponding size of the box to be carried.

For example, a map table of the box and the size information can be pre-stored in a system, and an identifier (for example, a two-dimensional code) may be disposed on the box to be carried. The box can be identified according to the identifier of the box to be carried, the size information of the box to be carried is obtained according to the map table of the box and the size information, and the spacing adjustment mechanism is controlled according to the obtained size information to adjust the spacing between the first fork arm and the second fork arm.

In an embodiment, the cargo carrying apparatus further includes a telescopic mechanism. A third shift lever capable of being stretched out towards a side of the second fork arm is disposed on an end of the first fork arm facing away from the target position, and a fourth shift lever capable of being stretched out towards a side of the first fork arm is disposed on an end of the second fork arm facing away from the target position. In steps S403 and S504, the cargo carrying apparatus is controlled to work so that the first fork arm and the second fork arm restrict the box to be carried, may include: relative position information between the box to be carried and the cargo carrying apparatus is determined according to the image information of the box to be carried; the telescopic mechanism is controlled according to the relative position information to work so that the box to be carried is located between the first fork arm and the second fork arm; and the third shift lever and the fourth shift lever are controlled to stretch out to hook the box to be carried.

It is to be understood that for a carrying robot without multiple layers of cargo positions, the box to be carried is carried directly from the bottom pallet to the target position. When the box to be carried is located on the bottom pallet, the box to be carried is located between the first fork arm and the second fork arm. However, since lengths of the first fork arm and the second fork arm are limited, the telescopic mechanism needs to be controlled to work so that the first fork arm and the second fork arm are moved to appropriate positions and the third shift lever and the fourth shift lever can restrict the box to be carried after the third shift lever and the fourth shift lever are stretched out.

For a carrying robot without multiple layers of cargo positions, after the third shift lever and the fourth shift lever are controlled to stretch out to hook the box to be carried, the telescopic mechanism is controlled to stretch out towards the target position, and the third shift lever and the fourth shift lever pull the box to be carried from the bottom pallet to the target position. For a carrying robot with multiple layers of cargo positions, after the third shift lever and the fourth shift lever are controlled to stretch out to hook the box to be carried, the telescopic mechanism is controlled to retract from the cargo position towards the bottom pallet, and the third shift lever and the fourth shift lever pull the box to be carried from the cargo position to the bottom pallet.

In a process of pulling the box to be carried by the third shift lever and the fourth shift lever, the first fork arm and the second fork arm well restrict the box to be carried.

In an embodiment, the cargo carrying apparatus further includes a telescopic mechanism. In steps S403 and S504, the cargo carrying apparatus is controlled to work so that the first fork arm and the second fork arm restrict the box to be carried, may include: relative position information of the box to be carried and the cargo carrying apparatus is determined according to the image information of the box to be carried; the telescopic mechanism is controlled according to the relative position information to work so that the box to be carried is located between the first fork arm and the second fork arm; the spacing adjustment mechanism is controlled to work to reduce the spacing between the first fork arm and the second fork arm; and in the case where the fitting pressure between the first fork arm and the box to be carried and the fitting pressure between the second fork arm and the box to be carried are greater than or equal to a preset pressure, the spacing adjustment mechanism is controlled to stop working to clamp the box to be carried.

For a carrying robot without multiple layers of cargo positions, after the spacing adjustment mechanism is controlled to stop working to clamp the box to be carried, the telescopic mechanism is controlled to stretch out towards the target position, and the third shift lever and the fourth shift lever pull the box to be carried from the bottom pallet to the target position. For a carrying robot with multiple layers of cargo positions, after the spacing adjustment mechanism is controlled to stop working to clamp the box to be carried, the telescopic mechanism is controlled to retract from the cargo position towards the bottom pallet, and the third shift lever and the fourth shift lever pull the box to be carried from the cargo position to the bottom pallet.

For the case where the carrying robot places a cargo at a target position, boxes with at least two specifications can be placed on the shelf. A position where the box to be carried is to be placed determined according to a current position of the box to be carried may not be matched with a specification of the box to be carried. For example, for the shelf, the box to be carried at a storage position is a box with a large specification, and a buffer storage location of a lower buffer layer board is determined according to the current position of the box to be carried. Since boxes with two specifications can be placed on the buffer board, the determined buffer storage location may be a buffer storage location for a box with a small specification, which is not suitable for the box to be carried with the large specification.

In an embodiment, for the case where the carrying robot places the cargo at the target position, the box carrying control method may further include: a first empty position is determined according to the current position of the box to be carried; whether the first empty position is matched with a specification of the box to be carried is determined; in the case where the first empty position is matched with the specification of the box to be carried, the first empty position is determined as the target position; and in the case where the first empty position is not matched with the specification of the box to be carried, a second empty position is determined according to the first empty position, and the second empty position is determined as the target position, where the second empty position is matched with the specification of the box to be carried.

It is to be understood that to improve carrying efficiency, the second empty position may be an appropriate position closest to the first empty position. For example, when a first buffer storage location determined according to the current position is not matched with the specification of the box to be carried, a second buffer storage location closest to the first buffer storage location can be found. In the case where the second buffer storage location is matched with the specification of the box to be carried, the second buffer storage location is determined as the target location.

Through the use of the technical solution of the embodiment of the present application, the carrying robot can place the box to be carried to the appropriate target position all the time to avoid a waste of shelf space.

The above box carrying control method may be applied to a warehouse system. The carrying robot is controlled to carry the box to be carried from the current position (for example, the storage position) to the target position (the buffer position) through the boxes carrying control method in the preceding embodiment. By using a carrying robot including multiple layers of cargo positions as an example, the application of the control method in the preceding embodiment is described in detail below through a process of carrying the box to be carried from the current position to the target position.

(1) After receiving a box carrying task from a task management system, a robot scheduling system determines a current position of the box to be carried according to the box to be carried. The scheduling system looks for a carrying robot in a state of capable of executing a task on a map. If there is no idle carrying robot, the scheduling system suspends the task and waits. If there is an idle carrying robot, the scheduling system plans a route to the current position for a carrying robot closest to the current position.

(2) The scheduling system sends an instruction and a route to move to the current position to the carrying robot, and the carrying robot moves to a current location corresponding to the current position according to the instruction and the route. The lifting apparatus adjusts the height of the cargo carrying apparatus so that the cargo carrying apparatus corresponds to a height of the current position.

(3) The spacing adjustment mechanism is controlled to adjust the spacing between the first fork arm and the second fork arm so that the spacing between the first fork arm and the second fork arm is matched with the box to be carried.

(4) The first fork arm and the second fork arm are controlled to restrict the box to be carried and carry the box to be carried to the bottom pallet.

(5) The lifting apparatus adjusts the height of the cargo carrying apparatus so that a height of the bottom pallet corresponds to a certain empty cargo position, and the first fork arm and the second fork arm can carry the box to be carried from the bottom pallet to the corresponding cargo position.

(6) The scheduling system plans a route from the current position to a target position and sends an instruction and a route to move to the target position to the carrying robot, and the carrying robot moves to the target location corresponding to the target position according to the instruction and the route.

(7) The lifting apparatus is controlled to work to adjust the height of the cargo carrying apparatus so that the height of the cargo carrying apparatus corresponds to a current cargo position of the box to be carried.

(8) The spacing adjustment mechanism is controlled to adjust the spacing between the first fork arm and the second fork arm so that the spacing between the first fork arm and the second fork arm is matched with the box to be carried.

(9) The first fork arm and the second fork arm are controlled to restrict the box to be carried and carry the box to be carried from the current cargo position to the bottom pallet.

(10) The lifting apparatus is controlled to work to adjust the height of the cargo carrying apparatus so that the height of the cargo carrying apparatus corresponds to the height of the target position of the box to be carried and the box to be carried is carried from the bottom pallet to the target position.

The box carrying control method in the embodiment of the present application may be applied to a warehouse system. Using the box carrying control method can control the carrying robot to carry a box between a buffer position in a buffer layer board of a shelf and a storage position in a storage layer board of the shelf, where boxes with different specifications can be placed on the shelf.

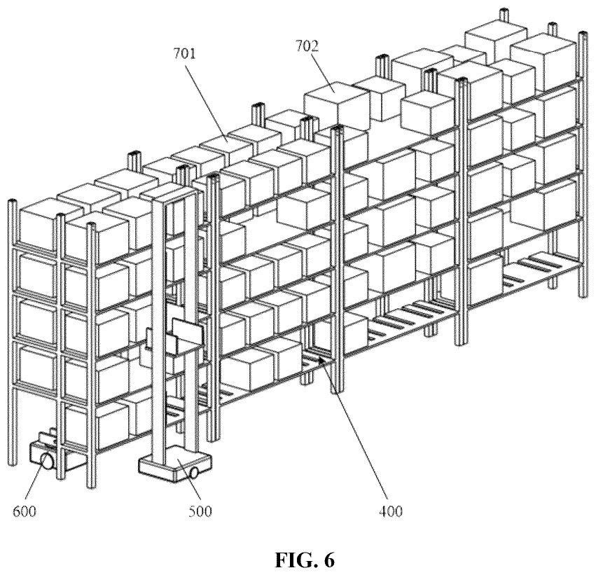

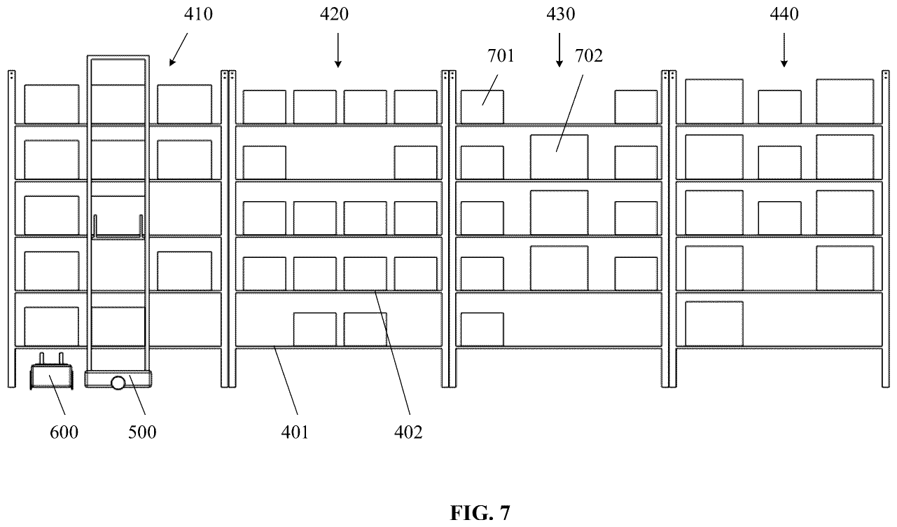

FIG. 6 is a perspective view of a warehousing apparatus according to an embodiment of the present application, and FIG. 7 is a plan view of a warehousing apparatus according to an embodiment of the present application. As shown in FIGS. 6 and 7, the warehousing apparatus may include multiple shelves 400, a carrying robot 500 and a transport robot 600. One shelf 400 may include at least one buffer layer board 401 and at least one storage layer board 402, where each of the at least one storage layer board 402 is spaced apart from the at least one buffer layer board 401 in a vertical direction, and one buffer layer board 401 and/or one storage layer board 402 is configured to be capable of accommodating boxes with at least two specifications, for example, a box 701 with a first specification and a box 702 with a second specification. Along an extension direction of the buffer layer board or the storage layer board, a size of the box 701 with the first specification is less than a size of the box 702 with the second specification. The carrying robot 500 is configured to carry a box between a buffer position and a storage position of the shelf, and the transport robot 600 is configured to transport a box between a buffer position and a workstation.

As shown in FIGS. 6 and 7, the storage layer board 402 is located above a respective one buffer layer board 401. In the case where the storage layer board 402 is configured to accommodate boxes with a single specification, a buffer storage location of the respective one buffer layer board 401 is consistent with a storage location of the storage layer board 402, that is, the size and number of buffer storage locations of the corresponding buffer layer board are the same as the size and number of storage locations of the storage layer board. It is to be understood that a buffer layer board located below the storage layer board may serve as the buffer layer board corresponding to the storage layer board, that is, the corresponding buffer layer board is the buffer layer board located below the storage layer board. For example, in a first shelf 410 in FIG. 7, the storage layer board 402 is configured to accommodate the boxes 702 with the second specification, and the storage layer board 402 has three storage locations. The corresponding buffer layer board 401 also has three buffer storage locations, and the buffer storage location is configured to accommodate boxes 702 with the second specification. For example, in a second shelf 420 in FIG. 7, the storage layer board 402 is configured to accommodate the boxes 701 with the first specification, and the storage layer board 402 has four storage locations. The corresponding buffer layer board 401 also has four buffer storage locations, and the buffer storage location is configured to accommodate the boxes 701 with the first specification.

In an embodiment, in the case where the at least one storage layer board is configured to accommodate boxes with a first specification and boxes with a second specification and a number of boxes with the first specification is greater than the number of boxes with the second specification, a size of the buffer storage location and the number of buffer storage locations of the respective one of the at least one buffer layer board are matched with the boxes with the first specification, and along an extension direction of the respective one buffer layer board, a size of a box with the first specification is less than a size of a box with the second specification. For example, in a third shelf 430 in FIG. 7, in the case where the storage layer board 402 is configured to accommodate the boxes 701 with the first specification and the boxes 702 with the second specification and the number of boxes 701 with the first specification is greater than the number of boxes 702 with the second specification, a size of the buffer storage location and the number of buffer storage locations of a respective one buffer layer board are matched with the boxes 701 with the first specification, the number of buffer storage locations of the respective one buffer layer board is four, and the buffer storage location is configured to accommodate the boxes 701 with the first specification.

In an embodiment, in the case where the at least one storage layer board is configured to accommodate boxes with the first specification and boxes with the second specification and the number of boxes with the second specification is greater than or equal to the number of boxes with the first specification, a size of the buffer storage location and a number of buffer storage locations of the respective one of the at least one buffer layer board are matched with the boxes with the second specification, and along the extension direction of the respective one buffer layer board, a size of the box with the first specification is less than a size of the box with the second specification. For example, in a fourth shelf 440 in FIG. 7, in the case where the storage layer board 402 is configured to accommodate the boxes 701 with the first specification and the boxes 702 with the second specification and the number of boxes 702 with the second specification is greater than the number of boxes 701 with the first specification, a size of the buffer storage location and the number of buffer storage locations of the respective one buffer layer board is matched with the boxes 702 with the second specification, the number of buffer storage locations of the respective buffer layer board is three, and the buffer storage location is configured to accommodate the boxes 702 with the second specification.

In an embodiment, in the case where the carrying robot is ready to carry a box to be carried from the at least one storage layer board towards a respective one buffer layer board, and in the case where the buffer storage location of the respective one buffer layer board is not matched with a specification of the box to be carried, the carrying robot is configured to carry the box to be carried from the respective one storage layer board towards a buffer layer board adjacent to the respective one buffer layer board so that a buffer storage location configured to accommodate the box to be carried is matched with the specification of the box to be carried. For example, when the box to be carried is the box 702 with the second specification located on the storage layer board of the third shelf 430, the carrying robot generally carries the box 702 with the second specification from the storage layer board to the respective one buffer layer board. However, since the buffer storage location of the buffer layer board of the third shelf 430 is matched with the box 701 with the first specification but not matched with the box 702 with the second specification, the box 702 with the second specification cannot be placed on the buffer storage location of the buffer layer board of the third shelf 430. Therefore, the carrying robot needs to carry the box to be carried (the box 702 with the second specification) from the storage layer board of the third shelf 430 towards a buffer layer board adjacent to the respective one buffer layer board. For example, the carrying robot can carry the box to be carried (the box 702 with the second specification) from the storage layer board of the third shelf 430 towards a buffer layer board of the fourth shelf 440 adjacent to the respective one buffer layer board, where the buffer storage location of the fourth shelf 440 is matched with the box with the second specification so that the box to be carried can be accommodated.

In the technical solution of the embodiment of the present application, the spacing adjustment mechanism adjusts the spacing between the first fork arm and the second fork arm so that the technical solution can adapt to the carrying of boxes with multiple specifications. In addition, boxes with different specifications can be carried to storage positions with a most appropriate size so that warehouse space is more effectively used.

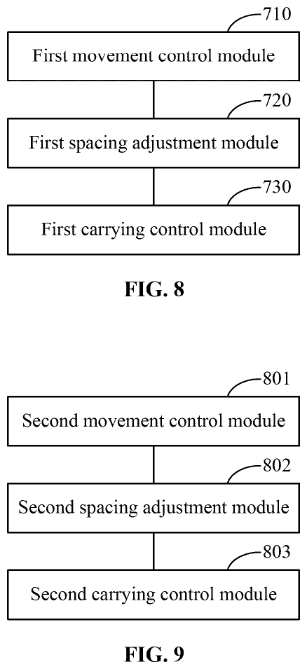

FIG. 8 is a block diagram of a box carrying control device according to an embodiment of the present application. An embodiment of the present application further provides a box carrying control device, which is performed by a carrying robot. The carrying robot may be applicable to a carrying scenario where boxes with at least two specifications are placed on a shelf. The carrying robot includes a cargo carrying apparatus. The cargo carrying apparatus includes a bottom pallet, a spacing adjustment mechanism, a first fork arm and a second fork arm. The first fork arm and the second fork arm are disposed opposite to each other. The first fork arm and the second fork arm are disposed on two opposite sides of the bottom pallet, respectively. As shown in FIG. 8, the box carrying control device may include a first movement control module 710, a first spacing adjustment module 720 and a first carrying control module 730.

The first movement control module 710 is configured to control the carrying robot to move so that a position of the cargo carrying apparatus corresponds to a position of a box to be carried.

The first spacing adjustment module 720 is configured to control the spacing adjustment mechanism to adjust spacing between the first fork arm and the second fork arm so that the spacing between the first fork arm and the second fork arm is matched with the box to be carried.

The first carrying control module 730 is configured to control the cargo carrying apparatus to work so that the first fork arm and the second fork arm restrict the box to be carried and carry the box to be carried to the bottom pallet.

In an embodiment, the first spacing adjustment module may include a first size information determination sub-module and a first spacing adjustment sub-module. The first size information determination sub-module is configured to determine size information of the box to be carried according to image information of the box to be carried, and the first spacing adjustment sub-module is configured to control, according to the size information of the box to be carried, the spacing adjustment mechanism to adjust the spacing between the first fork arm and the second fork arm.

In an embodiment, the cargo carrying apparatus further includes a telescopic mechanism, and the first carrying control module may include a first relative position determination sub-module, a first stretching out and retraction control sub-module and a first carrying control sub-module. The first relative position determination sub-module is configured to determine relative position information between the box to be carried and the cargo carrying apparatus according to the image information of the box to be carried, the first stretching out and retraction control sub-module is configured to control, according to the relative position information, the telescopic mechanism to stretch out so that the box to be carried is located between the first fork arm and the second fork arm, and the first carrying control sub-module is configured to control the first fork arm and the second fork arm to restrict the box to be carried and carry the box to be carried to the bottom pallet.

In an embodiment, a first shift lever capable of being stretched out towards a side of the second fork arm is disposed on an end of the first fork arm, and a second shift lever capable of being stretched out towards a side of the first fork arm is disposed on an end of the second fork arm. The first carrying control sub-module is configured to: control the first shift lever and the second shift lever to stretch out to hook the box to be carried; and control the telescopic mechanism to retract so that the first fork arm and the second fork arm pull the box to be carried to the bottom pallet.

In an embodiment, the first carrying control sub-module is configured to: control the spacing adjustment mechanism to work to reduce the spacing between the first fork arm and the second fork arm; in the case where a fitting pressure between the first fork arm and the box to be carried and/or a fitting pressure between the second fork arm and the box to be carried is greater than or equal to a preset pressure, control the spacing adjustment mechanism to stop working to clamp the box to be carried; and control the telescopic mechanism to retract so that the first fork arm and the second fork arm carry the box to be carried to the bottom pallet.

In an embodiment, the carrying robot further includes a lifting apparatus. The lifting apparatus is configured to adjust a height of the cargo carrying apparatus. The first movement control module may include a current position determination sub-module, a first instruction sub-module, a lifting control sub-module, a second relative position determination sub-module and a second instruction sub-module. The current position determination sub-module is configured to determine a current position corresponding to the box to be carried according to the box to be carried, the first instruction sub-module is configured to instruct the carrying robot to move to a current location corresponding to the current position, the lifting control sub-module is configured to control the lifting apparatus to work to move the cargo carrying apparatus to a height corresponding to the current position, the second relative position determination sub-module is configured to determine the relative position information between the box to be carried and the cargo carrying apparatus according to the image information of the box to be carried, and the second instruction sub-module is configured to instruct, according to the relative position information, the carrying robot to work to correct a position deviation between the cargo carrying apparatus and the box to be carried so that the position of the cargo carrying apparatus corresponds to the position of the box to be carried.

FIG. 9 is a block diagram of a box carrying control device according to another embodiment of the present application. An embodiment of the present application further provides a box carrying control device, which is performed by a carrying robot. The carrying robot may be applicable to a carrying scenario where boxes with at least two specifications are capable of being placed on a shelf. The carrying robot includes a cargo carrying apparatus. The cargo carrying apparatus includes a bottom pallet, a spacing adjustment mechanism, a first fork arm and a second fork arm. The first fork arm and the second fork arm are disposed opposite to each other. The first fork arm and the second fork arm are disposed on two opposite sides of the bottom pallet, respectively. The box carrying control device may include a second movement control module 801, a second spacing adjustment module 802 and a second carrying control module 803.

The second movement control module 801 is configured to control the carrying robot to move so that a position of the cargo carrying apparatus corresponds to a target position of a box to be carried.

The second spacing adjustment module 802 is configured to control the spacing adjustment mechanism to adjust spacing between the first fork arm and the second fork arm so that the spacing between the first fork arm and the second fork arm is matched with the box to be carried.

The second carrying control module 803 is configured to control the cargo carrying apparatus to work so that the first fork arm and the second fork arm restrict the box to be carried and carry the box to be carried from the bottom pallet to the target position.

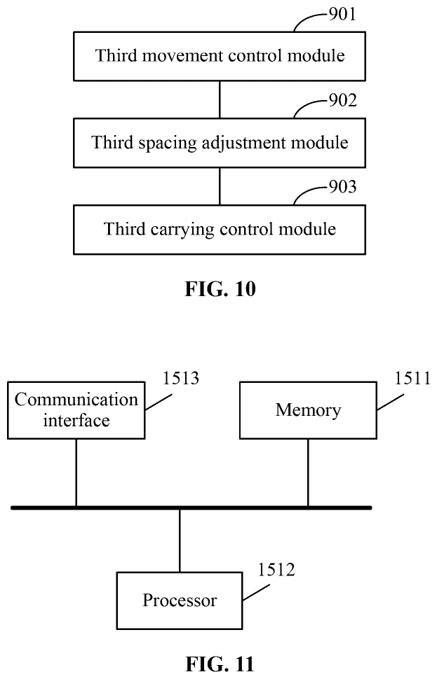

FIG. 10 is a block diagram of a box carrying control device according to another embodiment of the present application. An embodiment of the present application further provides a box carrying control device, which is configured as a carrying robot. The carrying robot may be applicable to a carrying scenario where boxes with at least two specifications are capable of being placed on a shelf. The carrying robot includes multiple layers of cargo positions, a cargo carrying apparatus and a lifting apparatus. The cargo carrying apparatus includes a bottom pallet, a spacing adjustment mechanism, a first fork arm and a second fork arm. The first fork arm and the second fork arm are disposed opposite to each other. The first fork arm and the second fork arm are disposed on two sides of the bottom pallet, respectively. The box carrying control device may include a third movement control module 901, a third spacing adjustment module 902 and a third carrying control module 903.

The third movement control module 901 is configured to: control the carrying robot to move so that a position of the cargo carrying apparatus corresponds to a target location of a target position of a box to be carried; and control the lifting apparatus to work so that a height of the cargo carrying apparatus corresponds to a current position of the box to be carried.

The third spacing adjustment module 902 is configured to control the spacing adjustment mechanism to adjust spacing between the first fork arm and the second fork arm so that the spacing between the first fork arm and the second fork arm is matched with the box to be carried.

The third carrying control module 903 is configured to: control the cargo carrying apparatus to work so that the first fork arm and the second fork arm restrict the box to be carried and carry the box to be carried from the current cargo position to the bottom pallet; and control the lifting apparatus to work so that the height of the cargo carrying apparatus corresponds to a height of the target position of the box to be carried and the box to be carried is carried from the bottom pallet to the target position.

In an embodiment, the second spacing adjustment module or the third spacing adjustment module may include a second size information determination sub-module and a second spacing adjustment sub-module. The second size information determination sub-module is configured to determine size information of the box to be carried according to image information of the box to be carried, and the second spacing adjustment sub-module is configured to control, according to the size information of the box to be carried, the spacing adjustment mechanism to adjust the spacing between the first fork arm and the second fork arm.

In an embodiment, the cargo carrying apparatus further includes a telescopic mechanism. A third shift lever capable of being stretched out towards a side of the second fork arm is disposed on an end of the first fork arm facing away from the target position, and a fourth shift lever capable of being stretched out towards a side of the first fork arm is disposed on an end of the second fork arm facing away from the target position. The second carrying control module or the third carrying control module may include a third relative position determination sub-module, a second stretching out and retraction control sub-module and a first restriction sub-module. The third relative position determination sub-module is configured to determine relative position information between the box to be carried and the cargo carrying apparatus according to the image information of the box to be carried; the second stretching out and retraction control sub-module is configured to control, according to the relative position information, the telescopic mechanism to work so that the box to be carried is located between the first fork arm and the second fork arm; and the first restriction sub-module is configured to control the third shift lever and the fourth shift lever to stretch out to hook the box to be carried.

In an embodiment, the cargo carrying apparatus further includes a telescopic mechanism, and the second carrying control module or the third carrying control module may include a third relative position determination sub-module, a third stretching out and retraction control sub-module, a second restriction sub-module and a pressure determination sub-module. The third relative position determination sub-module is configured to determine relative position information between the box to be carried and the cargo carrying apparatus according to the image information of the box to be carried; the third stretching out and retraction control sub-module is configured to control, according to the relative position information, the telescopic mechanism to work so that the box to be carried is located between the first fork arm and the second fork arm; the second restriction sub-module is configured to control the spacing adjustment mechanism to work to reduce the spacing between the first fork arm and the second fork arm; and the pressure determination sub-module is configured to control the spacing adjustment mechanism to stop working to clamp the box to be carried in the case where each of the fitting pressure between the first fork arm and the box to be carried and/or the fitting pressure between the second fork arm and the box to be carried is greater than or equal to a preset pressure.

An embodiment of the present application further provides a control device. The control device includes at least one processor and a memory communicatively connected to the at least one processor. The memory stores instructions executable by the at least one processor, and the instructions are executed by the at least one processor to cause the at least one processor to perform the method described above.

An embodiment of the present application further provides a warehouse system. The warehouse system includes the warehousing apparatus described above, the carrying robot described above and the control device described above. The control device is configured to control the carrying robot to carry a box.

An embodiment of the present application further provides a computer-readable storage medium which is configured to store computer programs that, when executed by a processor, implement the control method in the embodiment described above. The computer-readable storage medium may be a non-transitory computer-readable storage medium.

FIG. 11 is a block diagram of a control device according to an embodiment of the present application. As shown in FIG. 11, the control device includes a memory 1511 and a processor 1512. The memory 1511 stores a computer program which can be operated on the processor 1512. When executing the computer program, the processor 1512 performs the warehouse-in control method and the warehouse-out control method in the preceding embodiment. The number of memories 1511 and the number of processors 1512 may be one or more.

The control device further includes a communication interface 1513 configured to communicate with an external device to perform interactive transmission of data.

If the memory 1511, the processor 1512 and the communication interface 1513 are implemented independently, the memory 1511, the processor 1512 and the communication interface 1513 may be connected to each other and complete the communication with each other via a bus. The bus may be an Industry Standard Architecture (ISA) bus, a Peripheral Component Interconnect (PCI) bus or an Extended Industry Standard Architecture (EISA) bus. The bus may include an address bus, a data bus and a control bus. For ease of representation, the bus is only represented by one thick line in FIG. 11, which does not indicate that there is only one bus or one type of bus.

For example, in a specific implementation, if the memory 1511, the processor 1512 and the communication interface 1513 are integrated on a chip, the memory 1511, the processor 1512 and the communication interface 1513 may complete the communication with each other via an internal interface.

The above processor may be a central processing unit (CPU), or may be other general-purpose processors, a digital signal processor (DSP), an application-specific integrated circuit (ASIC), a field-programmable gate array (FPGA) or other programmable logic devices, discrete gates or transistor logic devices, or discrete hardware components. The general-purpose processor may be a microprocessor or any conventional processor. It is to be noted that the processor may be a processor that supports an Advanced RISC Machines (ARM) architecture.

For example, the above memory may include a program storage region and a data storage region, where the program storage region may store an operating system and an application program required by at least one function while the data storage region may store data created according to the use of the control device. In addition, the memory may include a high-speed random-access memory and a non-transitory memory, for example, at least one magnetic disk memory, a flash memory device or other non-transitory solid-state memories. In some embodiments, the memory may include memories which are remotely disposed relative to the processor and these remote memories may be connected to the control device via a network. Examples of the preceding network include, but are not limited to, the Internet, an intranet, a local area network, a mobile communication network, and a combination thereof.

In the above description, for the shelf, “position” may be expressed as “storage location”. For example, the “current position” on the shelf may be expressed as “current storage location”, and the “target position” may be expressed as “target storage location”.

In the description of the present specification, it is to be understood that the orientation or position relationships indicated by terms “center”, “longitudinal”, “lateral”, “length”, “width”, “thickness”, “above”, “below”, “front”, “back”,” “left”, “right”, “vertical”, “horizontal”, “top”, “bottom”, “inside”, “outside”, “clockwise”, “counterclockwise”, “axial”, “radial”, “circumferential”, etc. are based on the orientation or position relationships shown in the drawings, merely for facilitating description of the present application and simplifying description, and do not indicate or imply that the apparatus or element referred to has a specific orientation and is constructed and operated in a specific orientation, and thus it is not to be construed as limiting the present application.

Moreover, terms such as “first” and “second” are used only for the purpose of description and are not to be construed as indicating or implying relative importance or implicitly indicating the number of technical features indicated. Thus, a feature defined as a “first” feature or a “second” feature may explicitly or implicitly include one or more of this feature. In the description of the present application, the term “plurality” is defined as two or more, unless otherwise expressly specified and limited.

In the present application, unless otherwise expressly specified and limited, the term “installed”, “connected to each other”, “connected” or “fixed” is to be construed in a broad sense, for example, as fixedly connected, detachably connected, or integrated; mechanically connected, electrically connected, or communicatively connected; directly connected to each other or indirectly connected to each other via an intermediary; or internally connected between two elements or interactional relations between two elements. For those of ordinary skill in the art, specific meanings of the preceding terms in the present application may be construed according to specific circumstances.

In the present application, unless otherwise expressly specified and limited, when a first feature is described as “on” or “below” a second feature, the first feature and the second feature may be in direct contact or be in contact via another feature between the two features instead of being in direct contact. Moreover, when the first feature is described as “on”, “above” or “over” the second feature, the first feature is right on, above or over the second feature or the first feature is obliquely on, above or over the second feature, or the first feature is simply at a higher level than the second feature. When the first feature is described as “under”, “below” or “underneath” the second feature, the first feature is right on, above or over the second feature or the first feature is obliquely on, above or over the second feature, or the first feature is simply at a lower level than the second feature.

It is to be noted that although multiple steps of the method in the present application are described in a specific order in the drawings, this does not require or imply that the steps must be performed in the specific order, or that all the shown steps must be performed to achieve a desired result. Additionally or alternatively, certain steps may be omitted, multiple steps may be combined into one step to be performed, and/or one step may be divided into multiple steps to be performed. The above drawings are only exemplary descriptions according to the processing included in the method in the example embodiment of the present application and not intended to be limitative. It is easy to understand that the processing shown in the above drawings does not indicate or limit a time order of such processing. In addition, it is also easy to understand that such processing may be performed, for example, synchronously or asynchronously in multiple modules.

The above disclosure provides many different embodiments or examples for implementing different structures of the present application. To simplify the disclosure of the present application, components and configurations of particular examples are described above, which are, of course, illustrative only and are not intended to limit the present application. Moreover, the present application may repeat reference numbers and/or reference letters in different examples. Such repetition is for the purpose of simplification and clarity, and does not per se indicate a relationship between the discussed various embodiments and/or configurations.

1. A carrying robot, which is applicable to a carrying scenario where boxes with at least two specifications are placed on a shelf, comprising a movable chassis, a cargo carrying apparatus disposed on the chassis, and a lifting apparatus configured to adjust a height of the cargo carrying apparatus, wherein the cargo carrying apparatus comprises:
a first fork arm and a second fork arm, wherein the first arm and the second fork arm are disposed opposite to each other;
a spacing adjustment mechanism, wherein the spacing adjustment mechanism is connected to the first fork arm and the second fork arm and is configured to adjust spacing between the first fork arm and the second fork arm so that the spacing between the first fork arm and the second fork arm is matched with a box to be carried; and
a telescopic mechanism, wherein the telescopic mechanism is connected to the first fork arm and the second fork arm and is configured to control the first fork arm and the second fork arm to stretch out and retract.

2. The carrying robot according to claim 1, wherein the cargo carrying apparatus further comprises an image acquisition module configured to acquire image information of the box to be carried.

3. The carrying robot according to claim 1, wherein the carrying robot has at least one of the following configurations:
a first shift lever capable of being stretched out towards a side of the second fork arm is disposed on an end of the first fork arm, and a second shift lever capable of being stretched out towards a side of the first fork arm is disposed on an end of the second fork arm;
a first pressure detection module is disposed on one side of the first fork arm towards the second fork arm; or
a second pressure detection module is disposed on one side of the second fork arm towards the first fork arm.

4. A box carrying control method, which is performed by a carrying robot, the carrying robot being applicable to a carrying scenario where boxes with at least two specifications are placed on a shelf and comprising a cargo carrying apparatus, the cargo carrying apparatus comprising a bottom pallet, a spacing adjustment mechanism and a first fork arm and a second fork arm, the first fork arm and the second fork arm being disposed opposite to each other, and the first fork arm and the second fork arm being disposed on two opposite sides of the bottom pallet, respectively, and the method comprising:
controlling the carrying robot to move so that a position of the cargo carrying apparatus corresponds to a current position of a box to be carried;
controlling the spacing adjustment mechanism to adjust spacing between the first fork arm and the second fork arm so that the spacing between the first fork arm and the second fork arm is matched with the box to be carried; and
controlling the cargo carrying apparatus to work so that the first fork arm and the second fork arm restrict the box to be carried and carry the box to be carried from the current position to the bottom pallet.

5. The method according to claim 4, wherein the carrying robot further comprises an image acquisition module configured to acquire image information of the box to be carried, and before controlling the spacing adjustment mechanism to adjust the spacing between the first fork arm and the second fork arm, the method further comprises:
acquiring the image information of the box to be carried; and
controlling the spacing adjustment mechanism to adjust the spacing between the first fork arm and the second fork arm comprises:
determining size information of the box to be carried according to the image information of the box to be carried; and
controlling the spacing adjustment mechanism to adjust the spacing between the first fork arm and the second fork arm according to the size information of the box to be carried.

6. The method according to claim 4, wherein the cargo carrying apparatus further comprises a telescopic mechanism and an image acquisition module, wherein the telescopic mechanism is connected to the first fork arm and the second fork arm and configured to control the first fork arm and the second fork arm to stretch out and retract, and the image acquisition module is configured to acquire image information of the box to be carried, and before controlling the cargo carrying apparatus to work so that the first fork arm and the second fork arm restrict the box to be carried and carry the box to be carried from the current position to the bottom pallet, the method further comprises:
acquiring the image information of the box to be carried; and
controlling the cargo carrying apparatus to work so that the first fork arm and the second fork arm restrict the box to be carried and carry the box to be carried from the current position to the bottom pallet comprises:
determining relative position information between the box to be carried and the cargo carrying apparatus according to the image information of the box to be carried;
controlling, according to the relative position information, the telescopic mechanism to stretch out so that the box to be carried is located between the first fork arm and the second fork arm; and
controlling the first fork arm and the second fork arm to restrict the box to be carried and carry the box to be carried from the current position to the bottom pallet.

7. The method according to claim 6, wherein a first shift lever capable of being stretched out towards a side of the second fork arm is disposed on an end of the first fork arm, a second shift lever capable of being stretched out towards a side of the first fork arm is disposed on an end of the second fork arm, and controlling the first fork arm and the second fork arm to restrict the box to be carried and carry the box to be carried from the current position to the bottom pallet comprises:
controlling the first shift lever and the second shift lever to stretch out to hook the box to be carried; and
controlling the telescopic mechanism to retract so that the first fork arm and the second fork arm pull the box to be carried from the current position to the bottom pallet.

8. The method according to claim 6, wherein the carrying robot has at least one of the following configurations: a first pressure detection module is disposed on one side of the first fork arm towards the second fork arm, wherein the first pressure detection module is configured to detect a fitting pressure between the first fork arm and the box to be carried; or a second pressure detection module is disposed on one side of the second fork arm towards the first fork arm, wherein the second pressure detection module is configured to detect a fitting pressure between the second fork arm and the box to be carried; and
controlling the first fork arm and the second fork arm to restrict the box to be carried and carry the box to be carried from the current position to the bottom pallet comprises:
controlling the spacing adjustment mechanism to work to reduce the spacing between the first fork arm and the second fork arm;
in response to determining that at least one of a fitting pressure between the first fork arm and the box to be carried and a fitting pressure between the second fork arm and the box to be carried is greater than or equal to a preset pressure, controlling the spacing adjustment mechanism to stop working to clamp the box to be carried; and
controlling the telescopic mechanism to retract so that the first fork arm and the second fork arm carry the box to be carried from the current position to the bottom pallet.

9. The method according to claim 4, wherein the carrying robot further comprises a lifting apparatus and an image acquisition module, wherein the lifting apparatus is configured to adjust a height of the cargo carrying apparatus, and the image acquisition module is configured to acquire image information of the box to be carried, and before controlling the carrying robot to move so that the position of the cargo carrying apparatus corresponds to the current position of the box to be carried, the method further comprises:
acquiring the image information of the box to be carried; and
controlling the carrying robot to move so that the position of the cargo carrying apparatus corresponds to the current position of the box to be carried comprises:
determining the current position of the box to be carried according to the box to be carried;
instructing the carrying robot to move to a current location corresponding to the current position;
controlling the lifting apparatus to work to move the cargo carrying apparatus to a height corresponding to the current position;
determining relative position information between the box to be carried and the cargo carrying apparatus according to the image information of the box to be carried; and
instructing, according to the relative position information, the carrying robot to work to correct a position deviation between the cargo carrying apparatus and the box to be carried so that the position of the cargo carrying apparatus corresponds to the position of the box to be carried.

10. A box carrying control method, which is performed by a carrying robot, the carrying robot being applicable to a carrying scenario where boxes with at least two specifications are capable of being placed on a shelf and comprising a cargo carrying apparatus, the cargo carrying apparatus comprising a bottom pallet, a spacing adjustment mechanism and a first fork arm and a second fork arm, the first fork arm and the second fork arm being disposed opposite to each other, and the first fork arm and the second fork arm being disposed on two opposite sides of the bottom pallet, respectively, and the method comprising:
controlling the carrying robot to move so that a position of the cargo carrying apparatus corresponds to a target position of a box to be carried;
controlling the spacing adjustment mechanism to adjust spacing between the first fork arm and the second fork arm so that the spacing between the first fork arm and the second fork arm is matched with the box to be carried; and
controlling the cargo carrying apparatus to work so that the first fork arm and the second fork arm restrict the box to be carried and carry the box to be carried from the bottom pallet to the target position.

11. A box carrying control method, which is performed by a carrying robot, the carrying robot being applicable to a carrying scenario where boxes with at least two specifications are capable of being placed on a shelf and comprising multiple layers of cargo positions, a cargo carrying apparatus and a lifting apparatus, the cargo carrying apparatus comprising a bottom pallet, a spacing adjustment mechanism and a first fork arm and a second fork arm, the first fork arm and the second fork arm being disposed opposite to each other, the first fork arm and the second fork arm being disposed on two sides of the bottom pallet, respectively, and the method comprising:
controlling the carrying robot to move so that a position of the cargo carrying apparatus corresponds to a target location of a target position of a box to be carried;
controlling the lifting apparatus to work so that a height of the cargo carrying apparatus corresponds to a current cargo position of the box to be carried;
controlling the spacing adjustment mechanism to adjust spacing between the first fork arm and the second fork arm so that the spacing between the first fork arm and the second fork arm is matched with the box to be carried;
controlling the cargo carrying apparatus to work so that the first fork arm and the second fork arm restrict the box to be carried and carry the box to be carried from the current cargo position to the bottom pallet; and
controlling the lifting apparatus to work so that the height of the cargo carrying apparatus corresponds to a height of the target position of the box to be carried and the box to be carried is carried from the bottom pallet to the target position.

12. The method according to claim 10 or 11, wherein the carrying robot further comprises an image acquisition module configured to acquire image information of the box to be carried, and before controlling the spacing adjustment mechanism to adjust the spacing between the first fork arm and the second fork arm, the method further comprises:
acquiring the image information of the box to be carried; and
controlling the spacing adjustment mechanism to adjust the spacing between the first fork arm and the second fork arm comprises:
determining size information of the box to be carried according to the image information of the box to be carried; and
controlling, according to the size information of the box to be carried, the spacing adjustment mechanism to adjust the spacing between the first fork arm and the second fork arm.

13. The method according to claim 10 or 11, wherein the cargo carrying apparatus further comprises a telescopic mechanism and an image acquisition module, wherein the telescopic mechanism is connected to the first fork arm and the second fork arm and configured to control the first fork arm and the second fork arm to stretch out and retract, the image acquisition module is configured to acquire image information of the box to be carried, a third shift lever capable of being stretched out towards a side of the second fork arm is disposed on an end of the first fork arm facing away from the target position, and a fourth shift lever capable of being stretched out towards a side of the first fork arm is disposed on an end of the second fork arm facing away from the target position, and before controlling the cargo carrying apparatus to work so that the first fork arm and the second fork arm restrict the box to be carried, the method further comprises:
acquiring the image information of the box to be carried; and
controlling the cargo carrying apparatus to work so that the first fork arm and the second fork arm restrict the box to be carried comprises:
determining relative position information between the box to be carried and the cargo carrying apparatus according to the image information of the box to be carried;
controlling, according to the relative position information, the telescopic mechanism to work so that the box to be carried is located between the first fork arm and the second fork arm; and
controlling the third shift lever and the fourth shift lever to stretch out to hook the box to be carried.

14. The method according to claim 10 or 11, wherein the cargo carrying apparatus further comprises a telescopic mechanism and an image acquisition module, wherein the telescopic mechanism is connected to the first fork arm and the second fork arm and configured to control the first fork arm and the second fork arm to stretch out and retract, and the image acquisition module is configured to acquire image information of the box to be carried, and before controlling the cargo carrying apparatus to work so that the first fork arm and the second fork arm restrict the box to be carried, the method further comprises:
acquiring the image information of the box to be carried;
the carrying robot has at least one of the following configurations: a first pressure detection module is disposed on one side of the first fork arm towards the second fork arm, wherein the first pressure detection module is configured to detect a fitting pressure between the first fork arm and the box to be carried; or a second pressure detection module is disposed on one side of the second fork arm towards the first fork arm, wherein the second pressure detection module is configured to detect a fitting pressure between the second fork arm and the box to be carried; and
controlling the cargo carrying apparatus to work so that the first fork arm and the second fork arm restrict the box to be carried comprises:
determining relative position information of the box to be carried and the cargo carrying apparatus according to the image information of the box to be carried;
controlling, according to the relative position information, the telescopic mechanism to work so that the box to be carried is located between the first fork arm and the second fork arm;
controlling the spacing adjustment mechanism to work to reduce the spacing between the first fork arm and the second fork arm; and
in response to determining that at least one of the fitting pressure between the first fork arm and the box to be carried and the fitting pressure between the second fork arm and the box to be carried is greater than or equal to a preset pressure, controlling the spacing adjustment mechanism to stop working to clamp the box to be carried.

15. The control method according to claim 10, further comprising:
determining a first empty position according to the current position of the box to be carried;
determining whether the first empty position is matched with a specification of the box to be carried;
determining the first empty position as the target position based on a determination result that the first empty position is matched with the specification of the box to be carried; and
determining a second empty position according to the first empty position and determining the second empty position as the target position based on a determination result that the first empty position is not matched with the specification of the box to be carried, wherein the second empty position is matched with the specification of the box to be carried.

16. A control device, comprising:
at least one processor and
a memory communicatively connected to the at least one processor,
wherein the memory stores instructions executable by the at least one processor, and the instructions are executed by the at least one processor to cause the at least one processor to perform the method according to claim 4.

17. A warehouse system, comprising:
a plurality of shelves, wherein each of the plurality of shelves comprises at least one buffer layer board and at least one storage layer board, wherein each of the at least one storage layer board is spaced from each of the at least one buffer layer board in a vertical direction, and boxes with at least two specifications are capable of being placed on at least one of the each of the at least one buffer layer board and the each of the at least one storage layer board;
the carrying robot according to claim 1, wherein the carrying robot is configured to carry a box between the at least one storage layer board and the at least one buffer layer board; and
the control device according to claim 16.

18. The warehouse system according to claim 17, wherein each of the at least one storage layer board is located above a respective one buffer layer board of the at least one buffer layer board;
in response to determining that the each of the at least one storage layer board is configured to accommodate boxes with a single specification, a buffer storage location of the respective one buffer layer board is consistent with a storage location of the each of the at least one storage layer board;
in response to determining that the each of the at least one storage layer board is configured to accommodate boxes with a first specification and boxes with a second specification, and a number of boxes with the first specification is greater than a number of boxes with the second specification, a size of the buffer storage location and a number of buffer storage locations of the respective one buffer layer board of the at least one buffer layer board are matched with the boxes with the first specification, and along an extension direction of the respective one buffer layer board, a size of a box with the first specification is less than a size of a box with the second specification; and
in response to determining that the each of the at least one storage layer board is configured to accommodate boxes with the first specification and boxes with the second specification and the number of boxes with the second specification is greater than or equal to the number of boxes with the first specification, a size of the buffer storage location and a number of buffer storage locations of the respective one buffer layer board are matched with the boxes with the second specification, and along the extension direction of the respective one buffer layer board, the size of the box with the first specification is less than the size of the box with the second specification.

19. The warehouse system according to claim 18, wherein in response to determining that the carrying robot is ready to carry a box to be carried from the each of the at least one storage layer board towards the respective one buffer layer board and a buffer storage location of the respective one buffer layer board is not matched with a specification of the box to be carried, the carrying robot is configured to carry the box to be carried from the each of the at least one storage layer board towards a buffer layer board adjacent to the respective one buffer layer board so that a buffer storage location for accommodating the box to be carried is matched with the specification of the box to be carried.

20. A computer-readable storage medium which is configured to store computer programs that, when executed by a processor, implement the method according to claim 4.
